(19) United States
(12) Patent Application Publication
(10) Pub. No.: US 2015/0062895 A1
(43) Pub. Date: Mar. 5, 2015

(54) LED LAMP WITH A HEAT DISSIPATION STRUCTURE

(71) Applicant: Lediamond Opto Corporation, New Taipei City (TW)

(72) Inventors: Peng-Yu CHEN, New Taipei City (TW); Chung-Ting TSENG, New Taipei City (TW); Hsuan-Hsien LEE, New Taipei City (TW); Mu-Yin LU, New Taipei City (TW)

(73) Assignee: Lediamond Opto Corporation, New Taipei City (TW)

(21) Appl. No.: 14/167,596

(22) Filed: Jan. 29, 2014

(30) Foreign Application Priority Data
Sep. 2, 2013 (TW) 102131593

(51) Int. Cl. F21V 29/00; F21K 99/00

(52) U.S. Cl. CPC F21V 29/22; F21K 9/50
USPC 362/235

(57) ABSTRACT

A LED lamp includes an LED module and thermo-conductive members. The LED module has a transparent base, a plurality of LEDs mounted on the transparent base and a transparent film covering the LEDs. The transparent base has thermo-conductive sections and electro-conductive sections. The thermo-conductive members are attached on the thermo-conductive sections. Thereby, the invention can omnidirectionally emit light and has great effect of heat dissipation.

### BACKGROUND OF THE INVENTION

1. Technical Field

The invention relates to LED lamps, particularly to an LED lamp with a heat dissipation structure.

2. Related Art

A light emitting diode (LED) possesses advantages of low power-consumption, long life, compact volume and quick response, so it has been extensively applied in various lamps. For example, LED bulbs and tubes have become primary lighting products. However, LED lamps emit light only in a direction instead of multiple directions. This is a problem to be solved. Furthermore, an LED lamp usually uses a plurality of LED chips. This will generate considerable heat. Thus heat dissipation is another technical issue, too.

### SUMMARY OF THE INVENTION

An object of the invention is to provide an LED lamp with a heat dissipation structure, which can omnidirectionally emit light and has great effect of heat dissipation.

To accomplish the objection, the LED lamp of the invention includes an LED module and thermo-conductive members. The LED module has a transparent base, a plurality of LEDs mounted on the transparent base and a transparent film covering the LEDs. The transparent base has thermo-conductive sections and electro-conductive sections. The thermo-conductive members are attached on the thermo-conductive sections.

Another object of the invention is to provide an LED lamp with a heat dissipation structure, whose thermo-conductive members are shaped into clamps fastening on two sides of the transparent base. Thus, the heat from the LED can be dissipated by the clamps. Still another object of the invention is to provide an LED lamp with a heat dissipation structure, whose thermo-conductive members may include clamps and a fin module. The transparent base is fastened to the fin module by the clamps. Thus, the heat from the LED can be dissipated by the clamps and fin module.

Yet another object of the invention is to provide an LED lamp with a heat dissipation structure, whose thermo-conductive members can be made of metal, glass fiber or other materials. The transparent base is attached on the thermo-conductive members to transfer heat through the thermo-conductive members. Additionally, the LED lamp may be disposed with a thermo-conductive material (such as thermo-conductive gel or thermo-conductive silver) on the transparent base to enhance effect of heat transfer.

In comparison with the related art, the LED module of the LED lamp of the invention has a transparent base whose periphery includes thermo-conductive sections and electro-conductive sections. The thermo-conductive members are attached on the thermo-conductive sections. Thus, the light from the LED can be omnidirectionally emitted through the transparent base. An object of omnidirectionally lighting can be obtained. Furthermore, the heat from the LED can be dissipated by the thermo-conductive members, so the invention can accomplish a better effect of heat dissipation.

### BRIEF DESCRIPTION OF THE DRAWINGS

FIG. 1 is a perspective view of the invention;

FIG. 2 is an exploded view of the invention;

FIG. 3 is a sectional view of the invention;

FIG. 4 is an exploded view of the second embodiment of the invention;

FIG. 5 is a perspective view of the second embodiment of the invention;

FIG. 6 is a sectional view of the second embodiment of the invention;

FIG. 7 is an exploded view of the third embodiment of the invention;

FIG. 8 is a perspective view of the third embodiment of the invention; and

FIG. 9 is a sectional view of the fourth embodiment of the invention.

### DETAILED DESCRIPTION OF THE INVENTION

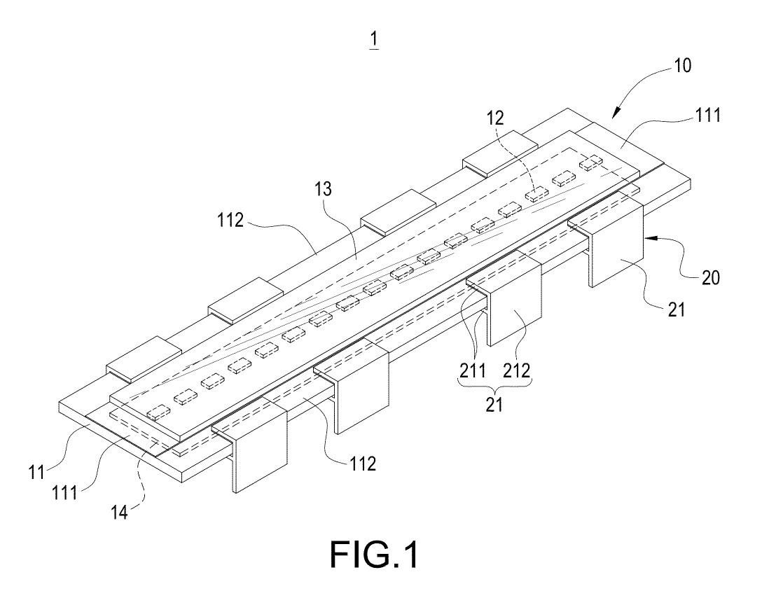

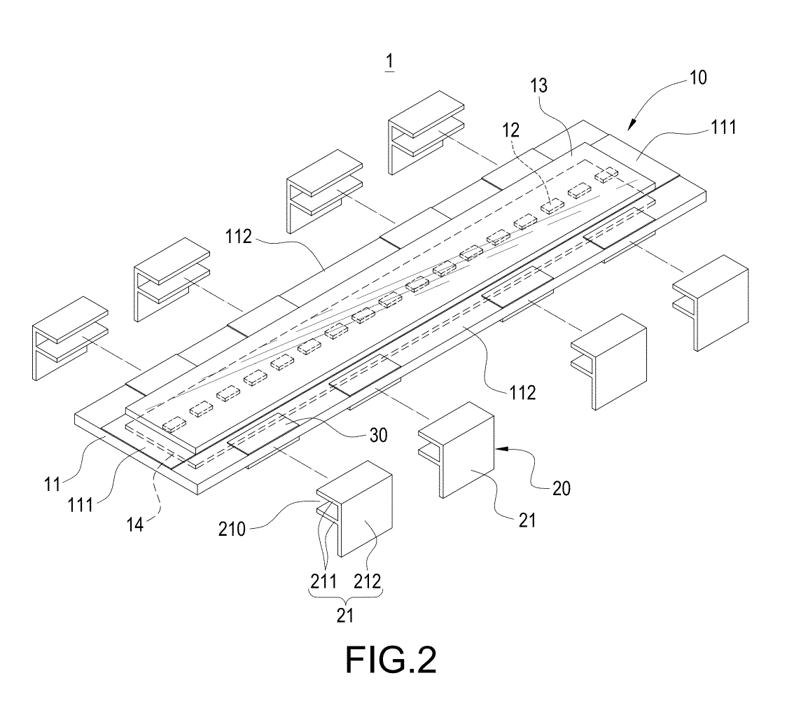

Please refer to FIGS. 1-3. The LED lamp 1 of the invention includes an LED module 10 and thermo-conductive members 20. The thermo-conductive members 20 connect the LED module 10 for heat dissipation.

The LED module 10 has a transparent base 11, a plurality of LEDs 12 mounted on the transparent base 11 and a transparent film 13 covering the LEDs 12. The transparent base 11 has a circuit layer (not shown), thermo-conductive sections 112 and electro-conductive sections 111. The LEDs 12 are electrically connected to the circuit layer and are arranged at linearly regular intervals. Another transparent film 14 is attached on the other side of the transparent base 11 against the transparent film 13. When the light from the LEDs 12 rays toward this side, the transparent film 14 can homogenize the light.

The transparent films 13, 14 may further include fluorescent powder (not shown). The fluorescent powder is used to convert wavelength of the light from the LEDs 12. That is, the light can be mixed to convert into another color.

The thermo-conductive members 20 are made of metal with great thermal conductivity, such as aluminum or copper. The thermo-conductive members 20 are attached on the thermo-conductive sections 112.

The LED lamp 1 may further include thermo-conductive films 30 attached on the thermo-conductive sections 112. The thermo-conductive members 20 are separately attached on the thermo-conductive films 30. The thermo-conductive films 30 can increase effect of heat transfer between the thermo-conductive sections 112 (the transparent base 11) and the thermo-conductive members 20. The thermo-conductive films 30 are omissible, i.e, the thermo-conductive members 20 is in direct contact with the transparent base 11. The thermo-conductive members 20 clamp two sides of the transparent base 11 to enhance the effect of heat transfer between the transparent base 11 and the thermo-conductive members 20.

Each of the thermo-conductive members 20 includes clamps 21 separately fastening on one of the thermo-conductive sections 112. In detail, the clamp 21 includes a pair of clamping sheets 211 and an extension sheet 212 connecting the clamping sheets 211. The clamps 21 separately fasten on two sides of the transparent base 11 (the thermo-conductive sections 112). An insertion space 210 is formed between the clamping sheets 211 for receiving the transparent base 11. The extension sheet 212 is perpendicular to the transparent base 11 to dispose the surface of the LED 12. In other words, the clamp 21 is of an F-shape, but not limited to this shape.

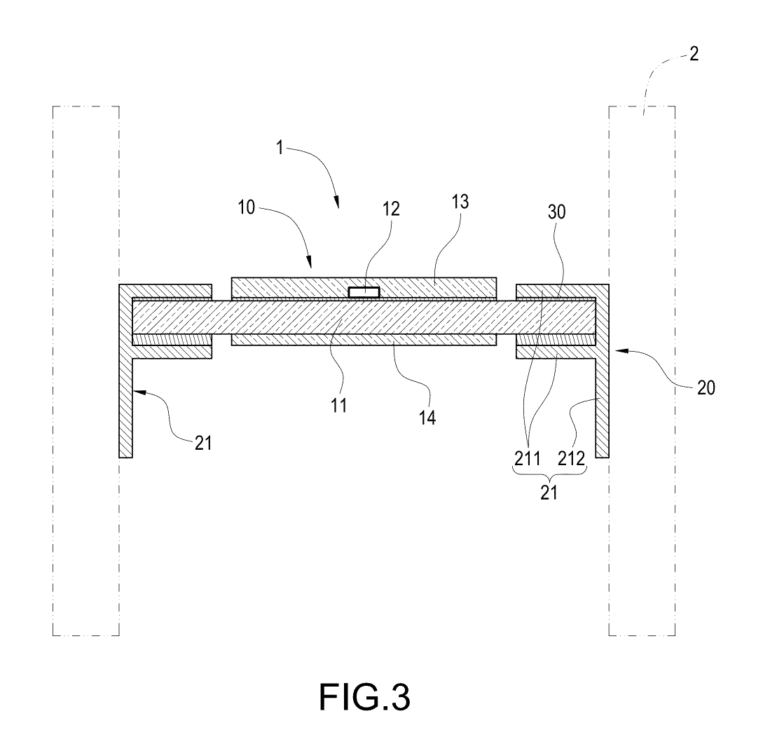

As shown in FIG. 3, after the clamps fasten on the thermo-conductive sections 112 of the transparent base 11, the heat from the LEDs 12 can be transferred to the clamps 21 via the thermo-conductive sections 112. When the LED lamp 1 is connected with a heat sink 2, the heat in the clamps 21 can be further transferred to the heat sink 2 to speed up the effect of heat dissipation. It should be noted that the light emitted by the LEDs 12 can ray from two opposite sides of the transparent base 11 for omnidirectional lighting.

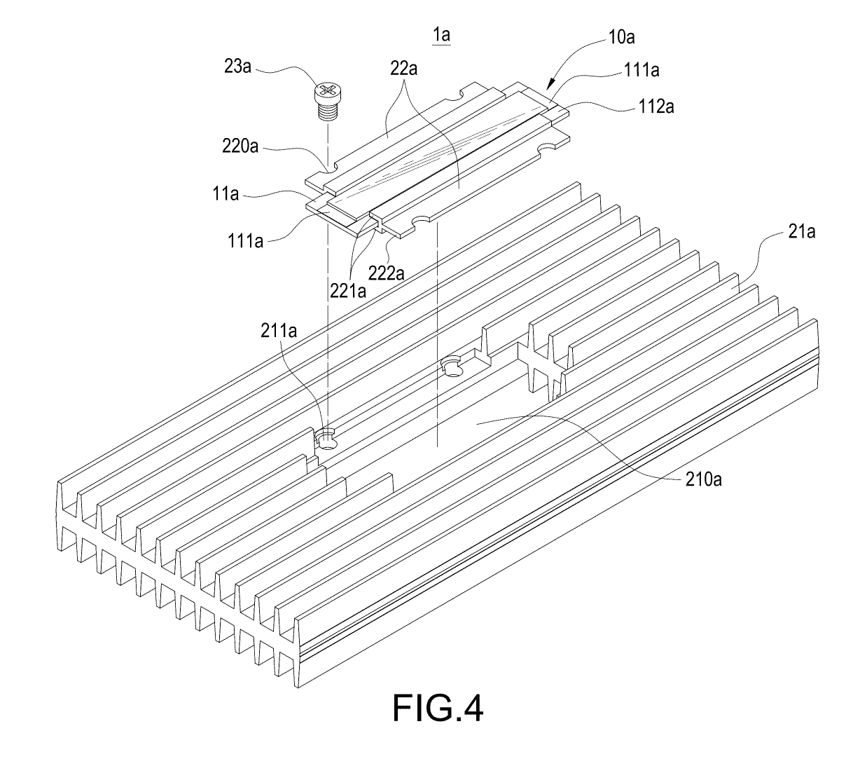

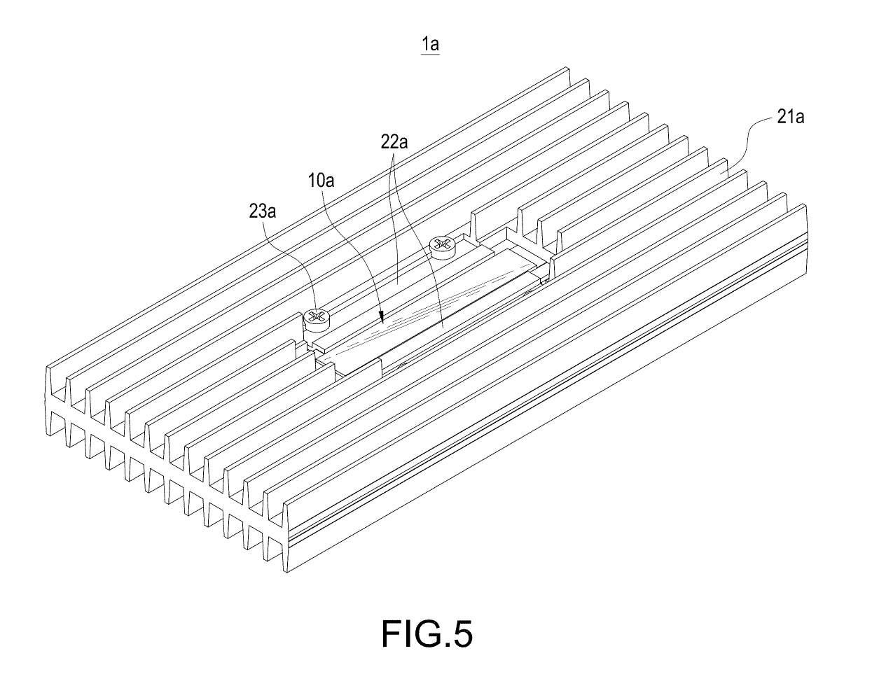

Please refer to FIGS. 4-6, which show the second embodiment of the invention. In this embodiment, the LED lamp la includes an LED module 10a and a thermo-conductive member 20a. The LED module 10a is the same as that of the first embodiment and has a transparent base 11a, a plurality of LEDs 12a mounted on the transparent base 11 a and a transparent film 13a covering the LEDs 12. The transparent base 11a has thermo-conductive sections 112a and electro-conductive sections 111a. The difference between the two embodiments is the thermo-conductive member 20a.

The thermo-conductive member 20a includes a fin module 21 a and clamps 22a connected to the fin module 21a. The clamps 22a are attached on the thermo-conductive sections 112a of the transparent base 11a. The fin module 21a is formed with an aperture 210a corresponding to the LED module 10a. The LED module 10a is secured in the aperture 210a by the clamps 22a. The light emitted by the LED module 10a can be rayed from the aperture 210a.

The clamp 22a includes a pair of clamping sheets 221 a clamping the transparent base 11a and an extension sheet 222a connecting the clamping sheets 221a. The extension sheet 222a is parallel to the transparent base 11 a to dispose the surface of the LEDs 12a. A section of the clamp 22a is of a Y-shape. Two sides of the transparent base 11a are clamped between the clamping sheets 221a. The extension sheet 222a is formed with open holes 220a. The fin module 21a is formed with connecting holes 211a. The LED module 10a is fixed in the fin module 21a by separately securing fasteners 23a in the open holes 220a and the connecting holes 211a.

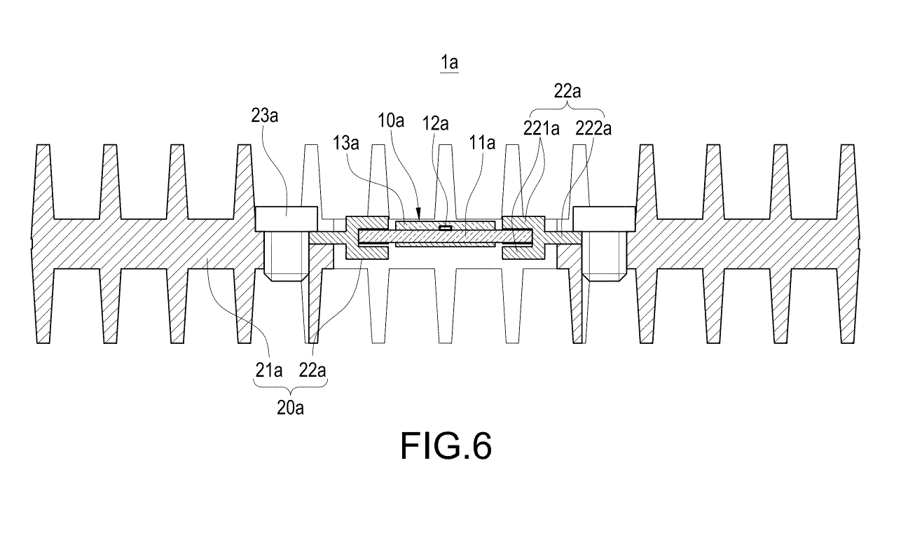

As shown in the FIG. 6, the clamps 22a separately clamp the thermo-conductive sections 112a on two sides of the transparent base 11a first, and then the fasteners 23a are used to secure the LED module 10a on the fin module 21a. The light emitted by the LEDs 12a can ray from two opposite sides of the transparent base 11a for omnidirectional lighting. Additionally, the heat from the LEDs 12a will be transferred to the clamps 22a and then to the fin module 21a. Finally, the heat will be dissipated by the fin module 21a.

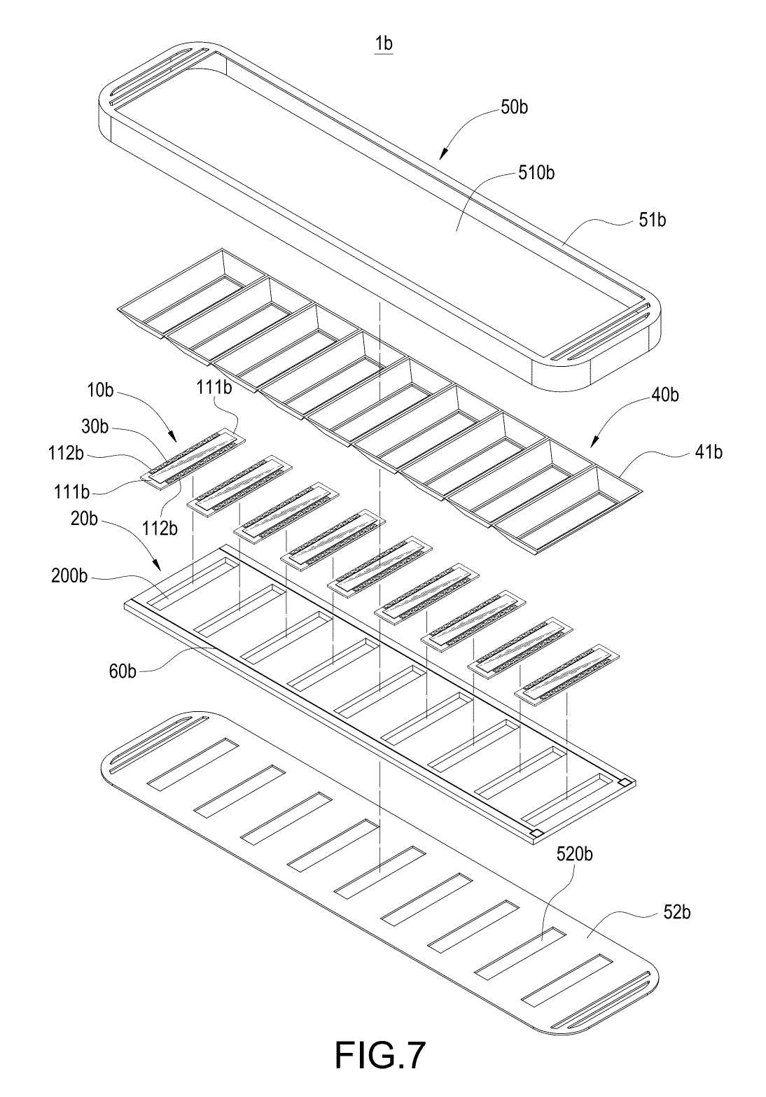

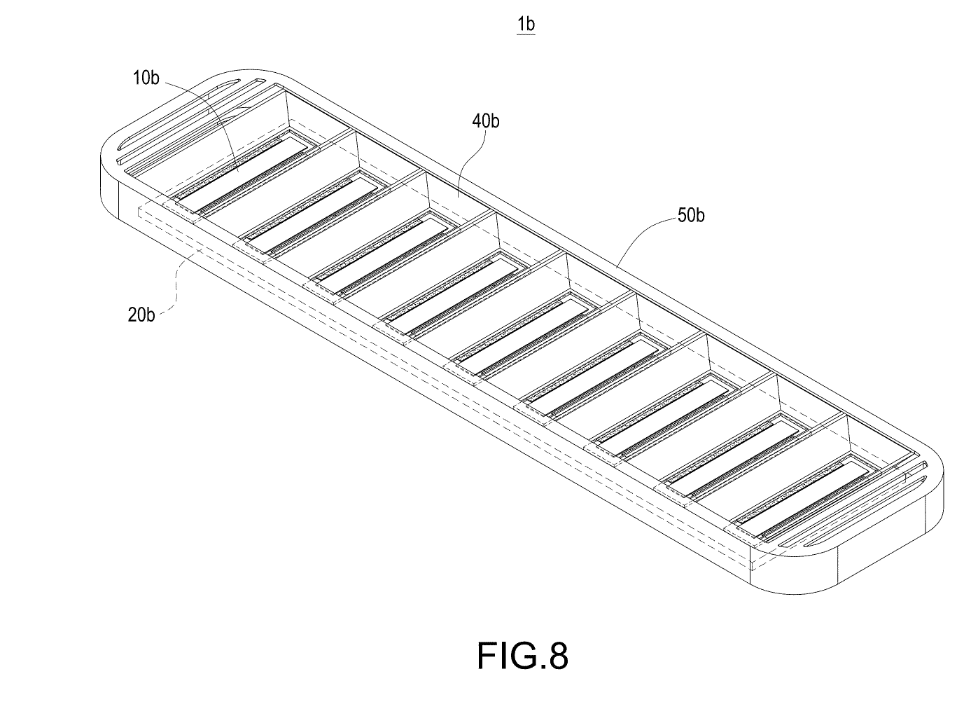

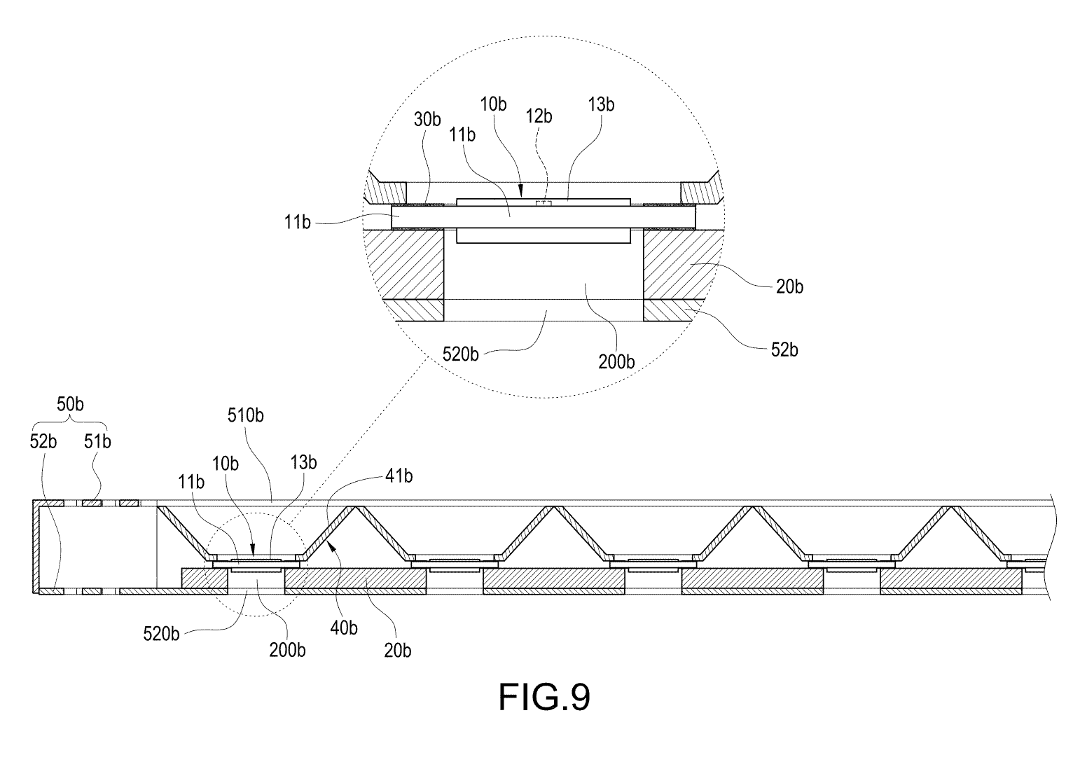

Please refer to FIGS. 7-9, which show the third embodiment of the invention. In this embodiment, the LED lamp 1b includes an LED module 10b and a thermo-conductive member 20b. The LED module 10b has a transparent base 11b, a plurality of LEDs 12b mounted on the transparent base 11b and a transparent film 13b covering the LEDs 12b. The transparent base 11bhas thermo-conductive sections 112b and electro-conductive sections 111b.

The difference between the first and third embodiments is the thermo-conductive member 20b. In this embodiment, the thermo-conductive member 20b is made of metal, glass fiber (FR4) or other materials. The thermo-conductive member 20b is provided with an opening 200b. The transparent base 11b is fixed on the thermo-conductive member 20b and the thermo-conductive sections 112b are beside the opening 200b.

Furthermore, the LED lamp lb includes a thermo-conductive silver layer 30b which is formed on two sides of the transparent base 11b for enhancing effect of heat transfer. The thermo-conductive member 20b is attached on the thermo-conductive silver layer 30b for enhancing effect of heat transfer between the thermo-conductive member 20b and the transparent base 11b.

The LED lamp 1b further includes a reflector 40b and a seat 50b. The reflector 40b surrounds the LED module 10b. The reflector 40b not only reflects the light from the LED module 10b, but also dissipates the heat from the LED module 10b. The heat from the LEDs 12b may also be transferred to the reflector 40b and then dissipated through the reflector 40b. That is, the reflector 40b also has an effect of heat dissipation. The seat 50b covers the reflector 40b and the thermo-conductive member 20b. The seat 50b includes an outer cover 51b and a bottom cover 52b connected thereto. The outer cover 51b is formed with a hollow 510b corresponding to the reflector 510b. The bottom cover 52b is formed with a slot 520b corresponding to the LED module 10b.

Preferably, the LED module 10b may be multiple in number and the opening 200b of the thermo-conductive member 20b is multiple for match. The openings 200b may be arranged in parallel or in matrix. Additionally, the thermo-conductive member 20b is provided with wires 60b which electrically connect to the electro-conductive sections 111b of the transparent base 11b. The reflector 40b includes reflective cups 41b corresponding to the LED modules 10b, for example, in an arrangement of straight line or array. Also, the slot 520b of the bottom cover 52b is multiple for corresponding to the LED modules 10b.

The description is that the light from the LED 12b will emit from two sides of the transparent base 11b to achieve the object of omnidirectionally lighting. Additionally, the LED modules 10b may be connected in series or parallel to provide required lighting, The wires are used to electrically connect the LED modules 10b in series or parallel.

While the forgoing is directed to preferred embodiments of the present invention, other and further embodiments of the invention may be devised without departing from the basic scope thereof. As such, the appropriate scope of the invention is to be determined according to the claims.

What is claimed is:

1. A light emitting diode (LED) lamp with a heat dissipation structure, comprising:
an LED module, having a transparent base, a plurality of LEDs mounted on the transparent base and a transparent film covering the LEDs, wherein the transparent base comprises thermo-conductive sections and electro-conductive sections; and
a plurality of thermo-conductive members, attached on the thermo-conductive sections.

2. The LED lamp of claim 1, further comprising thermo-conductive films attached on the thermo-conductive sections, wherein the thermo-conductive members are separately attached on the thermo-conductive films.

3. The LED lamp of claim 1, wherein each of the thermo-conductive members comprises clamps separately fastening on the thermo-conductive sections of the transparent base.

4. The LED lamp of claim 3, wherein the clamp comprises a pair of clamping sheets and an extension sheet connecting the clamping sheets, and an insertion space is formed between the clamping sheets for receiving the transparent base.

5. The LED lamp of claim 4, wherein the extension sheet is perpendicular to the transparent base to dispose a surface of the LEDs.

6. The LED lamp of claim 1, wherein the thermo-conductive member comprises a fin module and clamps connected to the fin module, and the clamps are attached on the thermo-conductive sections of the transparent base.

7. The LED lamp of claim 6, wherein the fin module is formed with an aperture corresponding to the LED module, and the LED module is secured in the aperture by the clamps.

8. The LED lamp of claim 6, wherein the clamp comprises a pair of clamping sheets and an extension sheet connecting the clamping sheets of the transparent base, and the transparent base is clamped between the clamping sheets

9. The LED lamp of claim 8, wherein the extension sheet is parallel to the transparent base to dispose a surface of the LEDs.

10. The LED lamp of claim 8, wherein the extension sheet is formed with open holes, the fin module is formed with connecting holes, and the LED module is fixed in the fin module by separately securing fasteners in the open holes and the connecting holes.

11. The LED lamp of claim 1, further comprising a thermo-conductive silver layer which is formed on the thermo-conductive sections, and the thermo-conductive member is attached on the thermo-conductive silver layer.

12. The LED lamp of claim 1, wherein the thermo-conductive member is made of metal or glass fiber, the thermo-conductive member is provided with an opening, and the transparent base is fixed on the thermo-conductive member and the thermo-conductive sections are beside the opening.

13. The LED lamp of claim 12, wherein the LED module is multiple in number, and the opening corresponds to the LED modules in number and position.

14. The LED lamp of claim 13, the thermo-conductive member is provided with wires which electrically connect to the electro-conductive sections.

15. The LED lamp of claim 1, further comprising a reflector and a seat, the reflector surrounds the LED module, and the seat covers the reflector and the thermo-conductive member.

16. The LED lamp of claim 15, wherein the reflector comprises reflective cups corresponding to the LED modules in arrangement.

17. The LED lamp of claim 15, wherein the seat comprises an outer cover and a bottom cover connected thereto, the outer cover is formed with a hollow corresponding to the reflector, and the bottom cover is formed with a slot corresponding to the LED module.
